(19) United States
(12) Patent Application Publication
(10) Pub. No.: US 2025/0006949 A1
(43) Pub. Date: Jan. 2, 2025

(54) METHOD FOR PRODUCING A GAS DIFFUSION LAYER, GAS DIFFUSION LAYER, FUEL CELL, AND DEVICE FOR PRODUCING A GAS DIFFUSION LAYER

(71) Applicant: Robert Bosch GmbH, Stuttgart (DE)

(72) Inventors: Elisabeth Buehler, Tamm (DE); Marcus Wegner, Leonberg (DE); Peter Lindner, Sersheim (DE); Ulrich Berner, Stuttgart (DE)

(21) Appl. No.: 18/712,038

(22) PCT Filed: Nov. 9, 2022
(86) PCT No.: PCT/EP2022/081302

§ 371 Date: May 21, 2024

(30) Foreign Application Priority Data
Nov. 23, 2021 (DE) 10 2021 213 141.7

(51) Int. Cl. H01M 4/86; C25B 9/19; C25B 11/032; C25B 11/069; H01M 4/88

(52) U.S. Cl. CPC H01M 4/8668; C25B 9/19; C25B 11/032; C25B 11/069; H01M 4/8807

(57) ABSTRACT

The invention relates to method for producing a gas diffusion layer (10) for a fuel cell (200), the method having the following steps:
mixing (120)
   elongated, electrically and thermally conductive fibers,
   electrically and thermally conductive conductivity particles,
   a binder for bonding the fibers and the conductivity particles, by means of at least one solvent to form at least one gas diffusion layer mixture (100a, 100b),
providing (140) a carrier body (30),
arranging (160) at least one layer (104a, 104b) of the at least one gas diffusion layer mixture (100a, 100b) on an upper face (31) of the carrier body (30),
removing (180) the solvent from the at least one gas diffusion layer mixture (100a, 100b) to produce the gas diffusion layer (10) on the upper face (31) of the carrier body (30).

### BACKGROUND

A fuel cell is an electrochemical cell. The fuel cell converts the energy of a chemical reaction of a fuel directly into electricity using an oxidizing agent. Various types of fuel cells exist. A specific fuel cell type is the polymer electrolyte membrane fuel cell.

Known fuel cells comprise gas diffusion layers comprising a microporous layer and a separate layer of carbon fiber fabric formed from the microporous layer. Disadvantageously, the production of gas diffusion layers comprising a microporous layer and a separate layer formed and produced from the microporous layer of carbon fiber fabric is carried out at very high temperatures, in particular temperatures above 1000° C., and are thus very expensive and costly to produce. Furthermore, such produced gas diffusion layers do not have optimal properties for operation of the fuel cell or a fuel cell stack.

### SUMMARY

The present invention shows a method for producing a gas diffusion layer, a fuel cell, and a device for producing a gas diffusion layer.

Further features and details of the invention arise from the disclosure. In this context, features and details described in connection with the method according to the invention clearly also apply in connection with the gas diffusion layer according to the invention, the fuel cell according to the invention and the device according to the invention, and respectively vice versa so that, with respect to the disclosure, mutual reference to the individual aspects of the invention is or can always be made.

According to a first aspect, the present invention shows a method for producing a gas diffusion layer for a fuel cell or an electrolyzer, wherein the method comprises a step of mixing elongated, electrically as well as thermally conductive fibers, preferably carbon fibers, as well as electrically and thermally conductive conductivity particles, preferably soot particles, as well as a binder, preferably PVDF and/or PTFE, for bonding the fibers and the conductivity particles, by means of at least one solvent, preferably NMP and/or DMSO, to form at least one gas diffusion layer mixture. Furthermore, the method comprises a step of providing a carrier body, for example a film. In addition, the method according to the invention comprises a step of arranging at least one layer of the at least one gas diffusion layer mixture on an upper face of the carrier body. Furthermore, the method comprises a step of removing the solvent from the at least one gas diffusion layer mixture for producing the gas diffusion layer on the upper face of the carrier body.

The method steps described hereinabove and hereinafter can be performed individually, together, once, several times, in parallel, and/or consecutively in any order, provided that doing so is technically feasible. A preferred order of the method steps provides that in a first step, the fibers, the conductivity particles and the binder are mixed to form at least one gas diffusion layer mixture by means of at least one solvent. In a subsequent step, at least one layer of the at least one gas diffusion layer mixture is arranged on an upper face of the provided carrier body. In an additional step, the gas diffusion layer mixture arranged on the upper face of the carrier body can be adjusted to a determinable thickness and/or smoothed, e.g. by a squeaking process. In a next step, the solvent is removed from the at least one gas diffusion layer mixture for producing the gas diffusion layer. In particular, in an additional step, the produced gas diffusion layer can be shaped to determinable dimensions. Furthermore, in an additional step, the produced gas diffusion layer can be detached, e.g. removed, from the carrier body.

The conductivity particles can in particular be primary particles and/or aggregates and/or agglomerates. The conductivity particles further serve in particular to electrically and thermally bond the fibers. The bonding of the fibers and the conductivity particles by means of the binder is in particular a permanent bonding. The binder forms in particular an electrically and thermally conductive “glue” with the conductivity particles. Thus, a particularly uniform thermal and electrical flow over the gas diffusion layer can be ensured. The binder can be, for example, PVDF (polyvinylidene difluoride) and/or PTFE (polytetrafluorethylene).

The solvent is used in particular for advantageous mixing of the fibers, the conductivity particles and the binder. It is further contemplated that several solvents can be employed for particularly advantageous mixing of the fibers, the conductivity particles and the binder. Preferably, only one solvent is used to keep the costs of producing the gas diffusion layer particularly low. In particular, NMP (N-methyl-2-pyrrolidone) and/or DMSO (dimethyl sulfoxide) can be used as solvents. Preferably, DMSO is used because NMP is classified as teratogenic.

The carrier body is in particular a plate-shaped body, for example a film. The carrier body can be arranged on an assembly unit, for example, a body having a planar surface, of an assembly device to provide the carrier body for the method for producing the gas diffusion layer.

The mixing of the fibers and/or the conductivity particles and/or the binder and/or the solvent and/or the stability particles and/or the pore formers and/or the radical scavenger can in particular be carried out by means of a mixing device, in particular by means of a rotational element of the mixing device.

Arranging the gas diffusion layer mixture on the upper face of the carrier body is in particular a metered arrangement, e.g. by means of a dosing unit of a dosing device. Several of the same and/or different gas diffusion layer mixtures can be arranged on the upper face of the carrier body, for example by means of a plurality of dosing units of the dosing device. It is also contemplated that a further layer of the same or one of a different gas diffusion layer mixture is arranged on a layer already arranged on the upper face of the carrier body.

In particular, a gas diffusion layer with only one layer is produced. A single-layer gas diffusion layer can be produced particularly inexpensively. In particular, multilayer gas diffusion layers are also conceivable.

Advantageously, a gas diffusion layer can be produced with the method according to the invention in a particularly simple and cost-efficient manner. Furthermore, a layer of the at least one gas diffusion layer mixture arranged on an upper face of the carrier body can advantageously form the properties of a microporous layer and a layer of carbon fiber fabric formed separately from the microporous layer. Furthermore, such a produced gas diffusion layer has particularly advantageous properties for operation of a fuel cell or a fuel cell system. Furthermore, the pore properties can also be influenced without pore formers. The properties of the gas diffusion layer can be controlled via the drying process and/or the composition of the gas diffusion layer mixture and/or viscosity. In particular, a gas diffusion layer with a porosity of between 50 to 80%, preferably between 55 to 70%, can advantageously be produced using the method according to the invention.

It can be advantageous for a method according to the invention for removing the solvent from the gas diffusion layer mixture, if the arranged gas diffusion layer mixture is dried, wherein a temperature for drying the gas diffusion layer mixture does not exceed 140° C., in particular 120° C. Thus, thermoplastics such as PVDV and/or PTFE can be used particularly advantageously as a binder. Advantageously, due to the low temperature for drying, a gas diffusion layer can be produced in a particularly inexpensive and simple manner. The drying can be a passive drying process. In other words, drying can be without actively supplying thermal energy, such that the solvent volatilizes over time. However, it is also contemplated that drying is an active drying process by actively supplying thermal energy, for example by heating. For example, an arrangement device for arranging the carrier body can comprise a heating element for actively supplying thermal energy for drying. In particular, active drying occurs at least temporarily at a temperature of between 60° to 200° C., preferably at least temporarily at a temperature of between 100° to 140° C.

For a method according to the invention, the fibers and the conductivity particles can be advantageously mixed to form a conductivity mixture by means of a solvent, and the binder (separated from the conductivity mixture) is mixed with a solvent to form a binder mixture, wherein subsequently the conductivity mixture and the binder mixture are mixed to form the gas diffusion layer mixture. Advantageously, a particularly advantageous gas diffusion layer mixture can thus be produced. For example, soot particles (as conductivity particles) or soot particles and graphite (as stability particles) can be mixed together with carbon fibers (as fibers) and DMSO (as solvents) in one step to form the conductivity mixture. In a further step, PVDV (as a binder) can be mixed together with DMSO (as a solvent) to form the bonding agent mixture, wherein subsequently the conductivity mixture with the bonding agent mixture is mixed to form the gas diffusion layer mixture.

With particular advantage, in a method according to the invention for arranging the gas diffusion layer mixture on the upper face of the carrier body, the solid portion of the gas diffusion layer mixture can be from 5 to 50 weight percent, in particular from 15 to 30 weight percent, relative to the total weight of the gas diffusion layer mixture. Thus, the gas diffusion layer mixture can be arranged particularly easily on the carrier body with a dosing unit of a dosing device.

According to a further preferred embodiment, in a method according to the invention, several layers of gas diffusion layer mixtures can be arranged one above the other to obtain a multilayer gas diffusion layer, wherein in particular at least two layers of the multilayer gas diffusion layer are based on a different gas diffusion layer mixture. Thus, a gas diffusion layer with particularly adapted properties can be produced. In particular, a first layer of a first gas diffusion layer mixture arranged on the upper face of the carrier body can be adjusted to a first determinable thickness, by means of a squeegee process for example, and subsequently at least one further layer of a second gas diffusion layer mixture is arranged on the first layer, in particular on a surface of the first layer, wherein the second layer is also adjusted to a determinable height by means of a squeegee process, for example. The first and second gas diffusion layer mixtures can be different, in particular have different properties. Thus, a gas diffusion layer can be produced that is less hydrophobic in the catalyst proximity so that the catalyst does not dry out, and wherein the gas diffusion layer on the flow field side is more hydrophobic so that process water can be discharged particularly rapidly from the fuel cell operation.

It can be advantageous if at least one surface of a gas diffusion layer mixture arranged on the carrier body is smoothed in a method according to the invention, in particular by means of a squeegee process. By smoothing, the fibers can be aligned on the surface of the gas diffusion layer mixture. Thus, the gas diffusion layer on the surface can particularly advantageously improve the properties of a conventional microporous layer. Smoothing by means of a squeegee process is in particular carried out by a squeegee blade after or during the arrangement of at least one layer of the at least one gas diffusion layer mixture on an upper face of the carrier body. The smoothed surface of the produced gas diffusion layer is in particular facing the membrane of the fuel cell in a fuel cell. The side of the produced gas diffusion layer facing the carrier body during the production of the gas diffusion layer is in particular facing away from the membrane of the fuel cell in a fuel cell.

Advantageously, for the method according to the invention, when mixing the fibers, conductivity particles and the binder to produce the at least one gas diffusion layer mixture, pore formers for forming pores in the gas diffusion layer and/or radical scavengers for inactivating radicals and/or stability particles, in particular graphite, for mechanically stabilizing the gas diffusion are additionally added. Thus, the properties of the gas diffusion layer can be particularly advantageously adjusted. The proportion of graphite as a stability particle is in particular up to 20 weight percent relative to the total weight of the gas diffusion layer.

According to a second aspect, the present invention shows a gas diffusion layer for a fuel cell or an electrolyzer, wherein the gas diffusion layer comprises 40 to 80 weight percent, in particular 50 to 70 weight percent, fibers, preferably carbon fibers, relative to the total weight of the gas diffusion layer. The fibers are elongated and electrically as well as thermally conductive fibers. Furthermore, the gas diffusion layer comprises 10 to 40 weight percent, in particular 15 to 30 weight percent, conductivity particles, preferably soot particles, relative to the total weight of the gas diffusion layer. The conductivity particles are electrically and thermally conductive. Additionally, the gas diffusion layer comprises 10 to 30 weight percent, in particular 15 to 25 weight percent, binder, preferably PVDF and/or PTFE, relative to the total weight of the gas diffusion layer. The binder bonds at least the fibers and the conductivity particles.

The dimensions, in particular diameter and/or length, of the conductivity particles are in particular smaller than the dimensions of the fibers.

It can be advantageous for a gas diffusion layer according to the invention if the fibers have a length of 50 to 6000 μm, in particular a length of 80 to 250 μm, and/or that the fibers have a diameter of 2 to 20 μm, in particular a diameter of 7 to 10 μm. A gas diffusion layer can thus be produced particularly inexpensively. In particular fibers with a length of 80 to 250 μm are particularly simple and thus inexpensive to manufacture.

Advantageously, a gas diffusion layer according to the invention can further comprise up to 20 weight percent graphite as stability particles relative to the total weight for mechanically stabilizing the gas diffusion layer. Graphite is particularly advantageous for mechanically stabilizing the gas diffusion layer. However, it is also conceivable to dispense with graphite completely in order to be able to produce a particularly simple and inexpensive gas diffusion layer.

Particularly advantageously, a gas diffusion layer according to the invention further comprises pore formers for forming pores in the gas diffusion layer and/or radical scavengers for inactivating radicals.

According to a further preferred embodiment, a gas diffusion layer according to the invention can be produced by means of a method according to the invention. Advantageously, a gas diffusion layer can be produced with the method according to the invention in a particularly simple and cost-efficient manner. Furthermore, a layer of the at least one gas diffusion layer mixture arranged on an upper face of the carrier body can particularly advantageously reproduce the properties of a conventional gas diffusion layer with a microporous layer and a layer of carbon fiber fabric formed separately from the microporous layer.

The gas diffusion layer according to the second aspect of the invention thus has the same advantages as have already been described for the method according to the first aspect of the invention.

According to a third aspect, the present invention shows a fuel cell comprising a membrane and a gas diffusion layer according to the invention, wherein in particular a smoothed surface of the gas diffusion layer faces the membrane of the fuel cell, or an electrolyzer comprising a membrane and a gas diffusion layer according to the invention, wherein in particular a smoothed surface of the gas diffusion layer faces the membrane of the electrolyzer.

The fuel cell according to the third aspect of the invention thus has the same advantages as have already been described for the method according to the first aspect of the invention or the gas diffusion layer according to the second aspect of the invention.

According to a fourth aspect, the present invention shows a device, wherein the device is configured to perform a method according to the invention for producing a gas diffusion layer.

The device comprises in particular a mixing device for mixing the fibers and/or the conductivity particles and/or the binder and/or the solvent and/or the stability particles and/or the pore formers and/or the radical scavenger, wherein mixing is carried out in particular by means of a rotational element of the mixing device. Furthermore, the device according to the invention can comprise a dosing device having at least one dosing unit for the dosed arrangement of a gas diffusion layer mixture on the upper face of the carrier body or on a layer already arranged on the carrier body. The device according to the invention can further comprise an arrangement device having an arrangement unit, for example a body having a planar surface, for arranging the carrier body, wherein the arrangement unit in particular comprises a heating element for actively supplying thermal energy for drying the gas diffusion layer mixture or the gas diffusion layer.

The device according to the fourth aspect of the invention thus has the same advantages as have already been described for the method according to the first aspect of the invention or the gas diffusion layer according to the second aspect of the invention or the fuel cell according to the third aspect of the invention.

Further measures improving the invention arise from the following description of a few embodiment examples of the invention, which are schematically represented in the figures. All of the features and/or advantages arising from the claims, description, or drawings, including structural details, spatial arrangements, and method steps, can be essential to the invention both by themselves and in the various combinations. It should be noted that the figures have only a descriptive character and are not intended to limit the invention in any way.

### BRIEF DESCRIPTION OF THE DRAWINGS

Schematically shown are:

FIG. 1 an embodiment of the method according to the invention,

FIG. 2 a further embodiment of the method according to the invention,

FIG. 3 a further embodiment of the method according to the invention,

FIG. 4 an embodiment of a gas diffusion layer according to the invention,

FIG. 5 an embodiment of a two-layer gas diffusion layer,

FIG. 6 a part of an embodiment of a fuel cell according to the invention, and

FIG. 7 an embodiment of a device according to the invention.

### DETAILED DESCRIPTION

In the following figures, identical reference numbers are used for identical technical features, even in different embodiment examples.

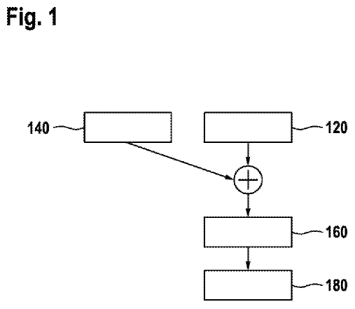

FIG. 1 discloses an embodiment of a method according to the invention for producing a gas diffusion layer 10, wherein the method provides that mixing 120 of the fibers, the conductivity particles as well as the binder takes place in one step by means of at least one solvent to form at least one gas diffusion layer mixture 100a. A carrier body 30, for example a film, is further provided 140. In a subsequent step, at least one layer 104a of the at least one gas diffusion layer mixture 100a is arranged 160 on an upper face 31 of the provided carrier body 30. In a next step, the solvent is removed from the at least one gas diffusion layer mixture 100a for producing the gas diffusion layer 10 on the upper face of the carrier body 180. In particular, in an additional step, the produced gas diffusion layer 10 can be shaped to determinable dimensions (not shown). Furthermore, in an additional step, the produced gas diffusion layer 10 can be detached, e.g. removed, from the carrier body (not shown).

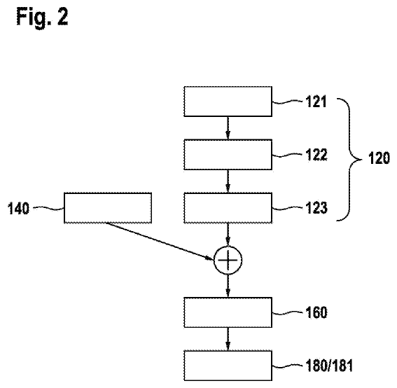

FIG. 2 discloses a further embodiment of a method according to the invention for producing a gas diffusion layer 10, wherein the method provides that in a step of the method, the fibers, in particular carbon fibers, and the conductivity particles, in particular soot particles, by means of a solvent, in particular NMP and/or DMSO, are mixed to form a conductivity mixture 121, and that the binder, in particular PVDV, are mixed with a solvent, in particular NMP and/or DMSO to form a bonding agent mixture 122, wherein subsequently the conductivity mixture and the bonding agent mixture are mixed to form a gas diffusion layer mixture 100a 123. The mixing 121 of the fibers and the conductivity particles by means of the solvent to form the conductivity mixture can be carried out in particular for 3 to 7 minutes, in particular 5 minutes, at 1500 to 2500 revolutions, in particular 2000 revolutions, with the aid of a rotational element. For example, the binding agent mixture can be a 10% solution consisting of PVDF and NMP. The mixing 123 of the conductivity mixture and the bonding agent mixture to form a gas diffusion layer mixture 100a can occur in particular for 3 to 7 minutes, in particular 5 minutes, at 1500 to 2500 revolutions, in particular 2000 revolutions, with the aid of a rotational element. A carrier body 30, for example a film, is further provided 140. In a subsequent step, at least one layer 104a of the at least one gas diffusion layer mixture 100a is arranged 160 on an upper face 31 of the provided carrier body 30. In a next step, the solvent is removed 180 from the at least one gas diffusion layer mixture 100a for producing the gas diffusion layer 10. The removal 180 of the solvent from the gas diffusion layer mixture 100a can be in particular a drying process 181, wherein preferably a temperature 100a of 140° C., in particular 120° C. for drying the gas diffusion layer mixture is not exceeded.

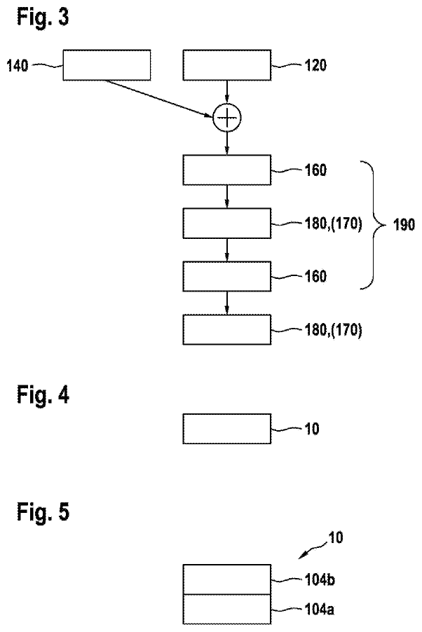

FIG. 3 shows a further embodiment of a method according to the invention, wherein the method provides that mixing 120 of the fibers, the conductivity particles as well as the binder takes place in one step by means of at least one solvent to form at least one gas diffusion layer mixture 100a. A carrier body 30, for example a film, is further provided 140. In a subsequent step, at least one layer 104a of the at least one gas diffusion layer mixture 100a is arranged 160 on an upper face 31 of the provided carrier body 30. In a next step, the solvent is removed 180 from the at least one gas diffusion layer mixture 100a for producing the gas diffusion layer 10 at the upper face 31 of the carrier body 30, wherein a surface 101 of the gas diffusion layer mixture 100a arranged on the carrier body 30 is smoothed 170 before or during removal 180 of the solvent. In particular after or during removal 180 of the solvent, a further layer 104b of a gas diffusion layer mixture 100b can be arranged 160 on the surface 101 of the first layer 104a. In a next step, the solvent is removed 180 from the further gas diffusion layer mixture 100b for producing the gas diffusion layer 10, wherein a surface of the gas diffusion layer mixture 100b arranged on the surface 100 of the first layer 104a is smoothed 170 before or during removal 180 of the solvent. Thus, a multilayer gas diffusion layer 10 can be produced

FIG. 4 shows an embodiment of a gas diffusion layer 10 according to the invention. The gas diffusion layer 10 is in particular plate-shaped and can be used, for example, in a fuel cell 200 or an electrolyzer 220. FIG. 5 shows an embodiment of a two-layer gas diffusion layer 10 as an example of a multilayer gas diffusion layer 10 having a first layer 104a and a second layer 104b arranged on the first layer 104a.

FIG. 6 schematically discloses a part of an embodiment of a fuel cell 200 according to the invention comprising a membrane 202 and a gas diffusion layer 10 according to the present invention, wherein a smoothed surface 101 of the gas diffusion layer 10 faces the membrane of the fuel cell 200. The fuel cell 200 can also be understood as an electrolyzer 220.

FIG. 7 shows an embodiment of a device 300 according to the invention for carrying out a method according to the invention for producing a gas diffusion layer 10 in a side view. The device 300 comprises an arrangement device having an arrangement unit 310, for example a conveyor belt, for arranging a carrier body 30. Furthermore, the device 300 comprises at least one dosing device having at least one dosing unit 320a for metered application of a first gas diffusion layer mixture 100a. By means of a squeegee process, a first layer 104a of the gas diffusion layer mixture 100a can be smoothed and brought to a determinable height. Smoothing by a squeegee process is performed by a squeegee blade 330a. Furthermore, the device 300 can additionally comprise at least one further dosing unit 320b for metered application of a second gas diffusion layer mixture 100b. The second gas diffusion layer mixture 100b can be the same as or different from the first gas diffusion layer mixture 100a. By means of a further squeegee blade 330b, a second layer 104b of the gas diffusion layer mixture 100b can be smoothed and brought to a determinable height. To accelerate the drying of the gas diffusion layer mixtures 100a, 100b, the arrangement device can comprise, for example, heating elements.

1. A method for producing a gas diffusion layer (10) for a fuel cell (200) or an electrolyzer (220), wherein the method comprises the following steps:
mixing (120)
elongated, electrically and thermally conductive fibers,
electrically and thermally conductive conductivity particles,
a binder, preferably PVDF and/or PTFE, for bonding the fibers and the conductivity particles,
by means of at least one solvent to form at least one gas diffusion layer mixture (100a, 100b),
providing (140) a carrier body (30),
arranging (160) at least one layer (104a, 104b) of the at least one gas diffusion layer mixture (100a, 100b) on an upper face (31) of the carrier body (30),
removing (180) the solvent from the at least one gas diffusion layer mixture (100a, 100b) for producing the gas diffusion layer (10) on the upper face (31) of the carrier body (30).

2. The method according to claim 1,
wherein
to remove (180) the solvent from the at least one gas diffusion layer mixture (100a, 100b), the arranged gas diffusion layer mixture (100a, 100b) is dried (181), wherein a temperature for drying the gas diffusion layer mixture (100a, 100b) does not exceed 140° C.

3. The method according to claim 1,
wherein
the fibers and the conductivity particles are mixed to form a conductivity mixture by means of a solvent (121), and the binder is mixed with a solvent to form a binder mixture (122), wherein subsequently the conductivity mixture and the binder mixture are mixed (123) to form the at least one gas diffusion layer mixture (100a, 100b).

4. The method according to claim 1,
wherein
to arrange (160) the at least one gas diffusion layer mixture (100a, 100b) on the upper face (31) of the carrier body (30), a solid portion of the at least one gas diffusion layer mixture (100a, 100b) is 5 to 50 weight percent relative to a total weight of the at least one gas diffusion layer mixture (100a, 100b).

5. The method according to claim 1,
wherein
several layers (104a, 104b) of gas diffusion layer mixtures (100a, 100b) are arranged on top of each other (190) to obtain a multilayer gas diffusion layer (10).

6. The method according to claim 1,
wherein
that at least one surface (101) of a gas diffusion layer mixture (100a, 100b) arranged on the carrier body (30) is smoothed (170).

7. The method according to claim 1,
wherein
upon mixing (120) the fibers, conductivity particles and the binder to produce the at least one gas diffusion layer mixture (100a, 100b), pore formers for forming pores in the gas diffusion layer (10) and/or radical scavengers for inactivating radicals and/or stability particles for mechanically stabilizing the gas diffusion (10) are additionally added.

8. A gas diffusion layer (10) for a fuel cell (200) or an electrolyzer (220), wherein the gas diffusion layer (10) comprises:
a. 40 to 80 weight percent fibers, wherein the fibers are elongated and electrically conductive as well as thermally conductive,
b. 10 to 40 weight percent conductivity particles, wherein the conductivity particles are electrically and thermally conductive,
c. 10 to 30 weight percentbinder, wherein the binder bonds at least the fibers and the conductivity particles,
wherein the weight percent specifications are each relative to a total weight of the gas diffusion layer (10).

9. The gas diffusion layer (10) according to claim 8,
wherein
the fibers have a length of 50 to 6000 μm and/or that the fibers have a diameter of 2 to 20 μm.

10. The gas diffusion layer (10) according to claim 8,
wherein
the binder comprises a thermoplastic plastic.

11. The gas diffusion layer (10) according to claim 8,
wherein
the gas diffusion layer (10) further comprises up to 20 weight percent graphite as stability particles relative to the total weight for mechanically stabilizing the gas diffusion layer (10).

12. The gas diffusion layer (10) according to claim 8,
wherein
the gas diffusion layer (10) further comprises pore formers for forming pores in the gas diffusion layer (10) and/or radical scavengers for inactivating radicals.

13. A gas diffusion layer (10) manufactured according to claim 1.

14. A fuel cell (200) comprising a membrane (202) and a gas diffusion layer (10) according to claim 8, wherein a smoothed surface (101) of the gas diffusion layer (10) faces the membrane of the fuel cell (200).

15. A device (300), wherein the device is configured to perform a method according to claim 1 for producing a gas diffusion layer (10).

16. An electrolyzer (220) comprising a membrane (202) and a gas diffusion layer (10) according to claim 8, wherein a smoothed surface (101) of the gas diffusion layer (10) faces the membrane of the electrolyzer (220).

17. The method according to claim 4, wherein to arrange (160) the at least one gas diffusion layer mixture (100a, 100b) on the upper face (31) of the carrier body (30), the solid portion of the at least one gas diffusion layer mixture (100a, 100b) is 15 to 30 weight percent, relative to the total weight of the at least one gas diffusion layer mixture (100a, 100b).

18. The method according to claim 5, wherein at least two layers (104a, 104b) of the multilayer gas diffusion layer (10) are based on a different gas diffusion layer mixture (100a, 100b).

19. The gas diffusion layer (10) according to claim 8, comprising:
a. 50 to 70 weight percent fibers,
b. 15 to 30 weight percent conductivity particles,
c. 15 to 25 weight percent binder, wherein the binder bonds at least the fibers and the conductivity particles.

20. The gas diffusion layer (10) according to claim 9, wherein the fibers have a length of 80 to 250 μm, and/or that the fibers have a diameter of 7 to 10 μm.
